(19) United States
(12) Patent Application Publication
(10) Pub. No.: US 2007/0236079 A1
(43) Pub. Date: Oct. 11, 2007

(54) System and method for enhanced end-of-train performance using locomotive consist communications

(75) Inventor: Robert C. Kull, Olney, MD (US)

Correspondence Address: THE WEBB LAW FIRM, P.C., 700 KOPPERS BUILDING, 436 SEVENTH AVENUE, PITTSBURGH, PA, 15219, US

(73) Assignee: Wabtec Holding Corp., Wilmerding, PA (US)

(21) Appl. No.: 11/728,177

(22) Filed: Mar. 23, 2007

Related U.S. Application Data
(60) Provisional application No. 60/785,623, filed on Mar. 24, 2006.

(51) Int. Cl. B60T 13/00

(52) U.S. Cl. 303/7

(57) ABSTRACT

A system and method for utilizing antenna diversity inherent in a locomotive consist is disclosed. This system increases the probability of message reception from an EOT unit and minimizes LCU failure limitations. The method includes the steps of (a) receiving an EOT message at a trailing locomotive; (b) passing the EOT message to a lead locomotive LCU; and (c) accepting the EOT message at the lead locomotive LCU only if the lead locomotive LCU has not already directly received the EOT message from the EOT unit.

### BACKGROUND OF THE INVENTION

1. Field of the Invention

The present invention relates generally to a system and method for improving End-of-Train (EOT) communications and, more particularly, for using locomotive consist communications to improve transmission and receipt of messages to and from an EOT device.

2. Description of Related Art

Typically, an End-of-Train device (EOT) communicates with a lead locomotive using two-way radio data communications. The communications device for facilitating communications in the locomotive includes a locomotive cab unit (LCU).

Standardized data communications from the EOT to the LCU includes transmission of messages relating to brake pipe pressure, motion status, other status messages and unit ID. For example, brake pipe pressure data may be transmitted when there is a change of at least 2 psi, or nominally at one minute update intervals. Motion status data may be transmitted when there is a change in movement that is detected at the EOT. Unit ID data is included in every message to provide a unique identifier with respect to the other transmitted data. Standardized data communications from the LCU to the EOT include transmission of messages relating to brake application requests, linking procedures and communications requests. For example, brake application requests include emergency or service braking EOT valve operation. Linking procedure messages may be used to set up an EOT ID for control by one specific train. Communications requests may be used by a locomotive to initiate a request for EOT data updates.

Prior art data radio links are established between the EOT and the LCU in the lead locomotive. The EOT data received by the lead locomotive is displayed to an engineer and is utilized in standard train operating procedures. Communications continuity may be challenging due to the train length position of the EOT antenna and terrain conditions. Typically, no direct line-of-sight exists for radio signal propagation. Therefore, successful communications normally depend upon reflection of signals from the surrounding terrain. As is the case with typical mobile data radio communications environments, multiple reflections of signals can create null points where the signals are lost, depending upon the location of a receiver antenna.

To accommodate some loss of data radio messages, EOT systems are designed to repeat important messages. However, the number of messages that are repeated needs to be balanced against the risk of creating channel congestion. This is especially true in light of a common set of radio channels being shared for EOT operation, which causes an EOT operating within the vicinity of other EOTs to operate in parallel therewith within the same radio range.

It is, therefore, desirable to overcome the above problems and others by providing a system and method for improving the reliability and efficiency of EOT system communications.

### SUMMARY OF THE INVENTION

The present invention is directed to a system and method of improving EOT communications and reliability by utilizing a locomotive consist communications (LCC) network with LCU devices in various locomotives of a locomotive consist (i.e., locomotives at a head of a train). Normally, a data radio link is formed only between the EOT and the LCU in the lead locomotive. The present invention utilizes the diverse antenna locations (e.g., lead and trailing locomotives have LCUs) to increase the probability of message reception. This overcomes geographic and LCU failure limitations. Accordingly, system reliability is increased. The present invention is implemented as follows. Timing slots are assigned to each trailing LCU to avoid message collisions when broadcasting repeat messages to the EOT. All LCU devices in each consist are set to receive messages, and the trailing units are configured to repeat any received messages to the lead locomotive. The lead LCU will act on its own upon directly receiving a message from the EOT. However, if the lead LCU does not receive the message, but instead receives a message from one of the trailing LCU devices within a set time frame, then the repeated message will be used instead. Lead LCU initiated penalty brake messages are communicated to the trailing LCU devices, which then broadcast the penalty brake messages according to predefined intervals.

The present invention provides the benefits normally associated with use of multiple receivers with diverse antenna locations, when in fact only one radio per locomotive is used. EOT transmissions may be received with multiple, diverse location antennas and receivers. Because trailing locomotives are closer to the EOT than is the lead locomotive, the probability of message reception is improved. Also, locomotive-to-EOT critical data communications (e.g., penalty brake commands) are more reliable when multiple trailing locomotives are used due to the diversity of hardware associated with the locomotive consist. Therefore, failure or poor performance of any transmitter within the locomotive consist would not preclude messages from being transmitted to the EOT. Safety regulatory and railroad internal safety rules may force reduction of train operating speeds when EOT communications are reduced or fail. Improving system reliability will reduce the occurrence of EOT failure-related operating restrictions. The present invention does not require any changes to be made to the EOT, to the device operation, or to the logic (as established in North American standards) to gain the aforementioned performance improvements. The present invention also supports the shared use of LCC networks for EOT enhancement.

Still other desirable features of the invention will become apparent to those of ordinary skill in the art upon reading and understanding the following detailed description, taken with the accompanying drawings, wherein like reference numerals represent like elements throughout.

### BRIEF DESCRIPTION OF THE DRAWINGS

FIG. 1 is a diagram illustrating the entities and communicative connectivity therebetween in a system for improving EOT communications in accordance with the present invention; and

FIG. 2 is a flowchart setting forth the basic steps of the transmission of data between locomotive consists and an EOT device in the present invention.

### DETAILED DESCRIPTION OF THE INVENTION

The present invention will now be described with reference to the accompanying figures. It is to be understood that the specific system illustrated in the attached figures and described in the following specification is simply an exemplary embodiment of the present invention.

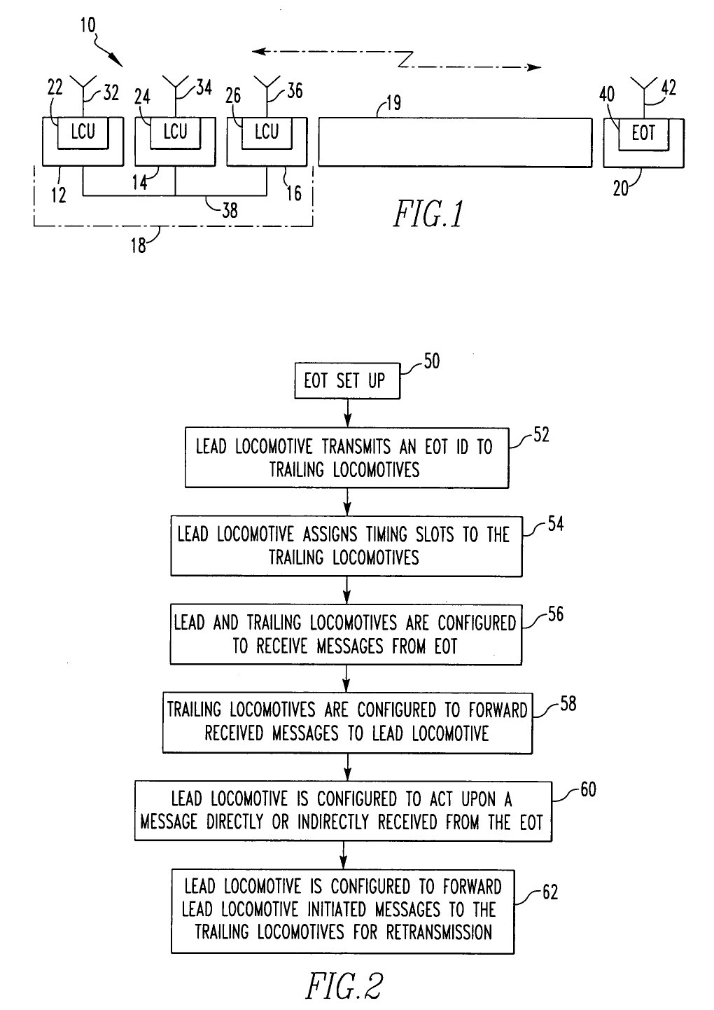

With reference to FIG. 1, the present invention is disclosed in connection with a train 10. The train 10 normally operates with multiple locomotives, such as a first locomotive 12, a second locomotive 14 and a third locomotive 16, all situated at the head of the train 10. The first locomotive 12, the second locomotive 14 and the third locomotive 16 collectively form a locomotive consist 18. The locomotive consist 18 includes a lead locomotive, which is the first locomotive 12, and trailing locomotives, which are the second locomotive 14 and third locomotive 16. The locomotive consist 18 is connected to any number of intermediary rail cars 19. A remote unit 20 is situated at the end of the train 10.

Each of the locomotives 12, 14, 16 generally includes a cab for housing related control and communication components responsible for the operation of the train 10. Specifically, the cabs of the first locomotive 12, the second locomotive 14 and the third locomotive 16 each have integrated therein a first LCU 22, a second LCU 24 and a third LCU 26, respectively. Each LCU (also known as an integrated cab computer) or similar hardware is configured to provide interaction with the communication components of the train 10. One such communication component is a transmitter (or transceiver) that is communicatively connected to the LCU. For example, the first LCU 22, the second LCU 24 and the third LCU 26 are connected to a first transmitter 32, a second transmitter 34 and a third transmitter 36 (or transceivers), respectively. Each transmitter is configured to send and receive data; namely, messages (e.g., LCU messages).

There are a variety of ways to establish data communications links, known as locomotive consist communications (LCC), between the locomotives 12, 14, 16. Examples of LCCs include (a) the addition of powerline communications as an overlay to existing multiple unit (MU) cabling, (b) the addition of a separate cable or trainline for data communications, and (c) separate data radio links between locomotives. Accordingly, a suitable LCC network 38 is established between the locomotives 12, 14, 16. However, these examples are not to be construed as limiting the invention. All of these implementations of an LCC network may provide similar capabilities, the most important of which is to allow the lead locomotive, i.e., the first locomotive 12, to send and receive data from selected trailing locomotives, e.g., the second locomotive 14, or all trailing locomotives, e.g., the second locomotive 14 and the third locomotive 16.

The remote unit 20 is generally associated with a last unit, rail car caboose, or similar nomenclature, at the rear of the train 10. The remote unit 20 has an End-of-Train unit (EOT) 40 associated therewith. The EOT 40 is generally configured to gather traditional EOT data. Although the EOT 40 is shown in connection with the remote unit 20, the EOT 40 may be associated with any one of the cars 19 or other rail vehicles that are situated near the rear of the train 10. The EOT 40 includes a transmitter 42 (or transceiver) communicatively connected thereto. Desirably, the transmitter 42 is configured to send and receive data (e.g., EOT messages). As is known in the art, each EOT 40 has a unique EOT ID associated therewith.

A method for improving EOT system communications reliability utilizing the aforementioned communicative entities will now be discussed. With continuing reference to FIG. 1, FIG. 2 depicts a flowchart for illustrating the major steps in implementing the present invention.

First, as is known in the art and will not be specifically discussed herein, EOT setup and arming thereof is initiated, as shown in block 50. Thereafter, as shown in block 52, the lead locomotive, via the corresponding LCU, communicates with any other LCUs of trailing locomotives within the same consist to advise these LCUs of the EOT ID of the EOT 40. For example, the first LCU 22 of the first locomotive 12 communicates with the second LCU 24 and the third LCU 26 of the second locomotive 14 and the third locomotive 16, respectively, via the LCC network 38 to pass along the EOT ID of the EOT 40.

Next, if more than one trailing locomotive is present in the locomotive consist, a “sequence number” is assigned by the LCU of the lead locomotive to define timing slots to avoid message collisions when broadcasting repeat messages to the EOT 40, as shown in block 54. For example, the locomotive consist 18 shown in FIG. 1 includes more than one trailing locomotive; namely, the second locomotive 14 and the third locomotive 16. Therefore, the first LCU 22 assigns a different “sequence number” to the second LCU 24 and the third LCU 26. Accordingly, the second LCU 24 and the third LCU 26 will not transmit when the first LCU 22 transmits. Similarly, the first LCU 22 and the third LCU 26 will not transmit when the second LCU 24 transmits. In essence, a transmitting order is established among the first, second, and third LCUs 22, 24, 26 to avoid message collisions when repeated messages are transmitted to the EOT 40.

The locomotive consist is configured to receive messages, as shown in block 56. For example, the first LCU 22, the second LCU 24, and the third LCU 26 of the respective locomotives 12, 14, 16 are configured to receive messages. However, no configuration changes are made to the EOT 40. Accordingly, EOT-initiated communications remain the same.

Each trailing locomotive is configured to forward received messages, as shown in block 58. For example, the second LCU 24 and the third LCU 26 are configured to communicate a repeat of any received messages over the LCC network 38 to the first locomotive 12.

The lead locomotive is configured to act on its own upon directly receiving a message, as shown in block 60. For example, the first LCU 22 will take the appropriate actions if the message received by the first LCU 22 has been directly received from the EOT 40. However, if the lead locomotive does not directly receive the message, but rather receives a message from one of the trailing locomotives, then that message is used instead, as also shown in block 60. For example, if the first LCU 22 does not directly receive the message from the EOT 40, but instead receives the same message (e.g., having the same content) from either the second LCU 24 or the third LCU 26, via the LCC network 38 within a set time frame, then that message will be processed by the first LCU 22. Therefore, it is to be understood that the first LCU 22 will not process messages forwarded by the second LCU 24 or the third LCU 26 if the first LCU 22 has already received the message directly from the EOT 40. The implementation may be designed to maintain the same number of message repeats as in a single unit operation in order to not take a larger portion than necessary of the channel use time per penalty brake application event.

The lead locomotive is also configured to forward lead-locomotive-initiated penalty brake messages (or other messages) to the trailing locomotives, as shown in block 62. Thereafter, the penalty brake messages are transmitted from the trailing locomotives to the EOT according to predefined intervals. For example, a penalty brake message is initiated in the first locomotive 12. The first LCU 22 then transmits the penalty brake message over the LCC network 38 to the second LCU 24 and the third LCU 26. As previously discussed, in the initial set up of the aforementioned system, the first LCU 22 assigns a “sequence number” to the second LCU 24 and the third LCU 26 to define timing slots to avoid message collisions when broadcasting repeat messages to the EOT 40. The established timing slots are then used to send the penalty brake message from the various LCUs 22, 24, 26 in such a manner so as to not overlap and create message collisions or unnecessary message congestion.

Optionally, the lead locomotive may be configured to assign its “lead” LCU communications responsibility to any of the trailing locomotives if radio failure or poor radio performance is detected in the lead locomotive. For example, the first LCU 22 may assign its role to either the second LCU 24 or the third LCU 26. In such situations, the data display and input functions between the first LCU 22 and engineer interface are maintained in the first locomotive 12. This is accomplished by transmitting the data originating in the first locomotive via the LCC network 38 to the newly-assigned “lead” LCU of the respective trailing locomotive, such as the second LCU 24.

It is to be understood that a typical hardware implementation of the present invention integrates two locomotive systems; namely, the EOT-LCU and the LCC. These systems may be integrated into a common physical package or as two separate packages having a data communications interface between the systems. In either case, an interface is provided to allow the LCC system to be shared for other consist communications functions. This may include, among other data, dynamic brake and tractive effort status data reporting from the trailing locomotives to the lead locomotive.

The teachings of the present invention may also be applied to other locomotive data radio system applications including, but not limited to, distributed power control and electronic train management systems. With respect to a distributed power control system, a lead locomotive may communicate with one or more sets of remote locomotives using data radio. If the lead and/or trailing locomotive groups include more than one locomotive, each having data radio equipment, the same approach as previously discussed may be applied. Specifically, one locomotive within each consist group would be designated as the “lead” for data radio communications purposes. When there are other equipped locomotives within their MU group having data radios and network communications therebetween, these locomotives may share message receipts in a similar manner as outlined with respect to EOT operations. Therefore, likewise, if a radio of a “lead” fails, then the “lead” designation within that particular locomotive group may be changed. With respect to an electronic train management system, a lead locomotive generally communicates with a network of ground data radios. When there are multiple locomotives, each having data radio equipment and network communications therebetween, communications may be shared in a similar manner as outlined with respect to EOT operations.

The invention has been described with reference to the desirable embodiments. Modifications and alterations will occur to others upon reading and understanding the preceding detailed description.

The invention claimed is:

1. A method of improving train communications wherein a train consist comprises a multiple locomotive consist at the head of the train consist, each locomotive having a locomotive consist communications system (LCC) for direct communications between locomotives in the locomotive consist, each locomotive having a locomotive communications unit (LCU) for communications with an end-of-train (EOT) unit positioned on the train consist remote from the locomotive consist, comprising the steps of:
establishing one of the locomotives in the locomotive consist as the lead locomotive and one or more others as trailing locomotives;
monitoring messages transmitted from the EOT unit with the LCU of all locomotives;
passing along the messages received from the EOT unit from a trailing locomotive to the lead locomotive;
acting on the passed-along received message by the lead locomotive if not received or not satisfactorily received directly from the EOT unit;
transmitting messages from the lead locomotive to the EOT unit and also passing the transmitted message to the one or more tailing locomotives; and
transmitting the passed-along transmitted message from one or more of the trailing locomotives to the EOT in non-conflicting time periods.

2. The method according to claim 1, comprising the step of assigning sequence numbers to the one or more trailing locomotives to establish the non-conflicting time periods.

3. A method of improving train communications wherein a train consist comprises a multiple locomotive consist at the head of the train consist, each locomotive having a locomotive consist communications system (LCC) for direct communications between locomotives in the locomotive consist, each locomotive having a locomotive communications unit (LCU) for communications with an end-of-train (EOT) unit positioned on the train consist remote from the locomotive consist, comprising the steps of:
establishing one of the locomotives in the locomotive consist as the lead locomotive and one or more others as trailing locomotives;
monitoring messages transmitted from the EOT unit with the LCU of each locomotive; and
passing along the messages received from the EOT unit from one or more trailing locomotives to the lead locomotive.

4. A method of improving train communications wherein a train consist comprises a multiple locomotive consist at the head of the train consist, each locomotive having a locomotive consist communications system (LCC) for direct communications between locomotives in the locomotive consist, each locomotive having a locomotive communications unit (LCU) for communications with an end-of-train (EOT) unit positioned on the train consist remote from the locomotive consist, comprising the steps of:
establishing one of the locomotives in the locomotive consist as the lead locomotive and one or more others as trailing locomotives;
transmitting messages from the lead locomotive to the EOT unit and also passing the transmitted message to the one or more tailing locomotives; and
transmitting the passed-along transmitted message from the one or more trailing locomotives to the EOT unit in non-conflicting time periods.

5. The method according to claim 1, comprising the step of assigning sequence numbers to the one or more trailing locomotives to establish the non-conflicting time periods.
